(19) United States
(12) Patent Application Publication
(10) Pub. No.: US 2020/0024900 A1
(43) Pub. Date: Jan. 23, 2020

(54) ADJUSTABLE LADDER AND STAIR SYSTEM

(71) Applicants: Willie Froese, Burnaby (CA); David Paul Stapleton, Burnaby (CA)

(72) Inventors: Willie Froese, Burnaby (CA); David Paul Stapleton, Burnaby (CA)

(21) Appl. No.: 15/791,371

(22) Filed: Oct. 23, 2017

(51) Int. Cl. E06C 1/38; E06C 1/36; E06C 7/50; E06C 7/18

(52) U.S. Cl. CPC E06C 1/38; E06C 7/181; E06C 7/50; E06C 1/36

(57) ABSTRACT

An adjustable ladder and stair system has a folding stair assembly including a ladder-member having a first-end, a second-end, a plurality of rungs equidistantly spaced between a first-rail and a second-rail, and a securer, a stair-member having a stair-portion, a first-rail-slide-mechanism, a second-rail-slide-mechanism, a first-rail-locking-mechanism, and a second-rail-locking-mechanism. The ladder-member may be secured in a vertical position parallel to a substantially vertical item desired to be ascended via the securer. The stair-member is adjustable to accommodate a desired angle. The folding stair assembly provides an apparatus for safely accessing a substantially vertical item desired to be ascended such as a roll off garbage bins.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of ladders and stairs and more specifically relates to a ladder and stair combination.

### 2. DESCRIPTION OF RELATED ART

A ladder is a vertical or inclined set of rungs or steps. There are generally two types: rigid ladders that are self-supporting or that may be leaned against a vertical surface such as a wall. The vertical members of a rigid ladder are called stringers or rails or stiles. Rigid ladders are usually portable, but some types are permanently fixed to a structure, building, or equipment. They are commonly made of metal, wood, or fiberglass, but they have been known to be made of tough plastic. Ladders can be unstable and not practical during certain applications.

Roll off garbage bins, typically used on all construction sites, have 8-foot sides. It is extremely difficult to throw the garbage up over the side. Currently the common practice, is to lean a ladder on a side of the roll off garbage bins, and carry the garbage up the ladder, or use the built-in ladder at the front of the roll off garbage bins. These practices are very dangerous, and not allowed by safety regulations. A suitable solution is desired.

U.S. Pat. No. 6,401,861 to Stephen James Marszalek relates to an adjustable floating ladder for loading a dumpster. The described adjustable floating ladder for loading a dumpster includes a free-floating step ladder which can hang on the rim of a trash dumpster having a stepless hook portion for hanging the ladder on the dumpster, a platform to stand on while loading the dumpster, and a stairway from the platform which extends adjustably toward the ground on which the dumpster rests without touching the ground.

### BRIEF SUMMARY OF THE INVENTION

In view of the foregoing disadvantages inherent in the known ladders and stairs art, the present disclosure provides a novel adjustable ladder and stair system. The general purpose of the present disclosure, which will be described subsequently in greater detail, is to provide a ladder and stair combination for providing an efficient and safe way to access garbage bins, roofs or other hard to reach areas.

An adjustable ladder and stair system is disclosed herein. The adjustable ladder and stair system includes a folding stair assembly including a ladder-member having a first-end, a second-end, a plurality of rungs equidistantly spaced between a first-rail and a second-rail, and a securer, a stair-member having a stair-portion, a first-rail-slide-mechanism, a second-rail-slide-mechanism, a first-rail-locking-mechanism, and a second-rail-locking-mechanism. In a preferred embodiment, the stair-member further includes at least one hand rail.

The plurality of rungs may include open ends to engage the first-rail-locking-mechanism and the second-rail-locking-mechanism so the stair-member may be locked in to place approximately every 12 inches. The stair-portion comprises a run of approximately 9 inches and a rise of approximately 8 inches with a distance of 12 inches from nosing to nosing. The folding stair assembly provides an apparatus for accessing a substantially vertical item desired to be ascended such as a garbage bin, formwork, wood walls, or other items.

The first-end comprises the securer for attaching to a substantially vertical item desired to be ascended and securing the folding stair assembly in position for use. The first-rail-slide-mechanism and the second-rail-slide-mechanism are positioned at a top-portion on opposing sides of the stair-portion and are configured to allow the stair-portion to pivot and further move along the first-rail and the second-rail. The first-rail-slide-mechanism comprises the first-rail-locking-mechanism and the second-rail-slide-mechanism comprises the second-rail-locking-mechanism which are configured to lock the first-rail-slide-mechanism; the second-rail-slide-mechanism, and the stair-portion respectively at a desired user-selected position via fastening to the open ends of one of the plurality of rungs on the first-rail and the second-rail.

The first-rail-slide-mechanism and the second-rail-slide-mechanism comprises a c-shaped profile configured to engage the first-rail and the second-rail as a track and move in relation to the first-end to the second-end of the ladder-member. The first-rail-locking-mechanism and the second-rail-locking-mechanism comprise a cam handle and safety pin. The cam handle, when lifted, retracts the safety pin and allows for adjustability. The safety pin secures the first-rail-slide-mechanism, the second-rail-slide-mechanism, and the stair-portion at a desired position. The stair-portion pivots to a sufficient angle in relation to the substantially vertical item desired to be ascended.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an adjustable ladder and stair system, constructed and operative according to the teachings of the present disclosure.

FIG. 1 is a perspective view of the adjustable ladder and stair system during an ‘in-use’ condition, according to an embodiment of the disclosure.

FIG. 2 is a perspective view of the adjustable ladder and stair system of FIG. 1, according to an embodiment of the present disclosure.

FIG. 3 is a perspective view of the adjustable ladder and stair system of FIG. 1, according to an embodiment of the present disclosure.

FIG. 4 is a perspective view of the adjustable ladder and stair system of FIG. 1, according to an embodiment of the present disclosure.

FIG. 5 is a perspective view of the adjustable ladder and stair system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a ladders and stairs and more particularly to an adjustable ladder and stair system as used to improve an efficient ladder and stair combination for use on different items that a user may wish to ascend.

Generally, the present invention includes a folding stair device that attaches to a large roll-off garbage bins used in the construction industry. The adjustable ladder and stair system hooks onto a side of the roll-off garbage bin, and a stair-member folds out. The folding of the stairs is adjustable, for different size bins, as well as terrain. The roll-off garbage bin may also be transported, with the stairs folded up to the side of the bin.

The present device may be used in several applications (methods of use). In a garbage bin application, the user may take the folding stairs, and walk up to the side of a roll-off garbage bin of varying heights and hook the top portion on the side of the roll-off garbage bin. The unit will automatically hang on the side of the bin, in a vertical position. A user may then take one hand and grab the stair-portion made of expanded metal. Hand holes may be included in the expanded metal are there to make this action safe and easy). With the other hand, the user may unlock a safety mechanism, on either side of the step portion. Now the user is able to pull the stair-portion out until it is positioned at the desired angle for walking up. At this point, the user may lock safety pins on either side of the stair-portion. Next, the user may grab a hold of the hand rail, and lift it to a vertical position. A user may then safely access the stair-portion with garbage.

The adjustable ladder and stair system may be used in a wood framing application. The device may hook on a wood wall. The securer may be adjusted to accommodate a wide wood wall. A user may access a top plate, to nail corners or nail trusses on. The device when hooked on a wall, gives plumbers and electricians safe access for getting their plumbing and wires through the top of the wall, into the ceiling.

In a concrete forming application, the present invention may hook onto formwork, giving a user safe access, to upper concrete ties on tall forms. It would give the user safe access, to stand and fill the forms with concrete, rather than stand on the top of the form. The folding steps are safer than other forms of ladders, because the ground is always very irregular around concrete formwork.

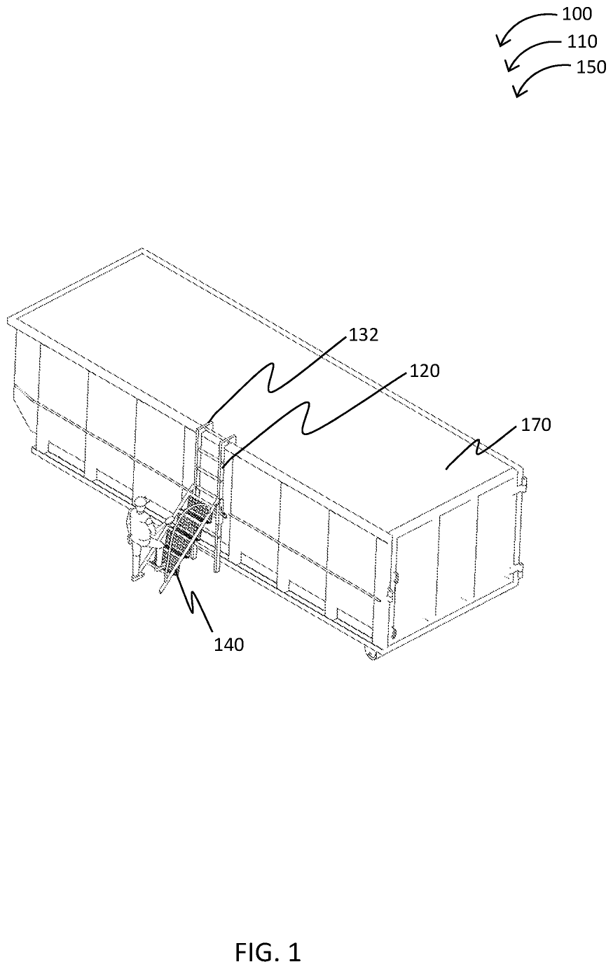

Referring now more specifically to the drawings by numerals of reference, there is shown in FIGS. 1-5, various views of an adjustable ladder and stair system 100. FIG. 1 shows an adjustable ladder and stair system 100 during an ‘in-use’ condition 150, according to an embodiment of the present disclosure. As illustrated, the adjustable ladder and stair system 100 may include a folding stair assembly 110 including a ladder-member 120 having a first-end 122, a second-end 124, a plurality of rungs 126 equidistantly spaced between a first-rail 128 and a second-rail 130, and a securer 132, a stair-member 140 having a stair-portion 142, a first-rail-slide-mechanism 144, a second-rail-slide-mechanism 146, a first-rail-locking-mechanism 160, and a second-rail-locking-mechanism 162.

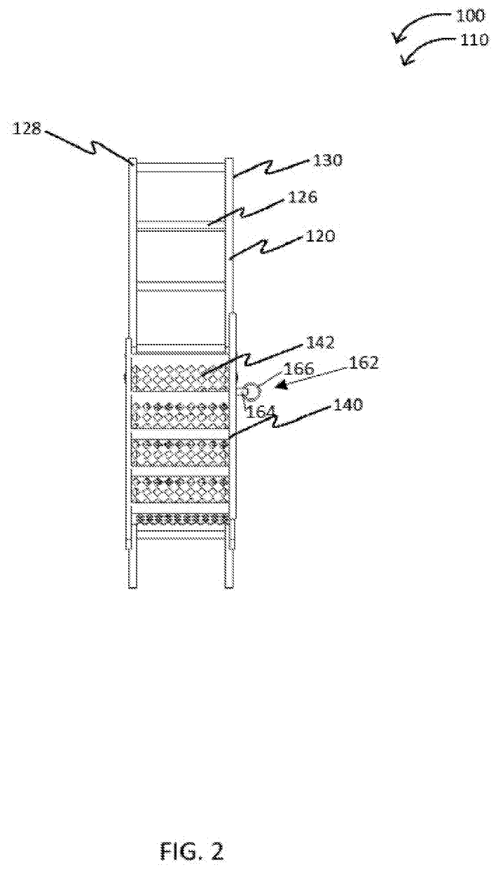

FIG. 2 shows a perspective view of the adjustable ladder and stair system 100 of FIG. 1, according to an embodiment of the present disclosure. As above, the adjustable ladder and stair system 100 may include the folding stair assembly 110 having the ladder-member 120 and the stair-member 140. The plurality of rungs 126 on the ladder-member may be separated by 12 inches along the first-rail 128 and the second-rail 130. The plurality of rungs 126 may include open ends to engage the first-rail-locking-mechanism 160 and the second-rail-locking-mechanism 162 such that the stair-member 140 may be locked in to place approximately every 12 inches. The stair-portion 142 comprises a run of approximately 9 inches and a rise of approximately 8 inches with a distance of 12 inches from nosing to nosing. Other rise and run options may be available to comply with safety standards.

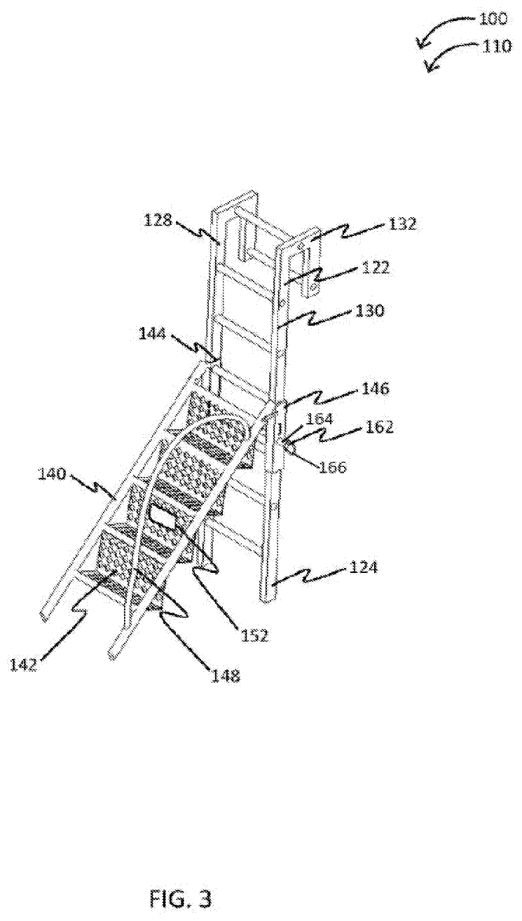

FIG. 3 shows a perspective view of the adjustable ladder and stair system 100 of FIG. 1, according to an embodiment of the present disclosure. As above, the adjustable ladder and stair system 100 may include the ladder-member 120 having the first-end 122, the second-end 124, the plurality of rungs 126 equidistantly spaced between the first-rail 128 and the second-rail 130, and the securer 132. The first-end 122 comprises the securer 132 for attaching to an item and securing the folding stair assembly 110 in position for use. The second-end 124 is in contact with a planar surface such as a ground surface.

The first-rail-slide-mechanism 144 and the second-rail-slide-mechanism 146 are positioned at a top-portion 143 on opposing sides of the stair-portion 142 and are configured to allow the stair-portion 142 to pivot and further move along the first-rail 128 and the second-rail 130. The first-rail-slide-mechanism 144 comprises the first-rail-locking-mechanism 160 and the second-rail-slide-mechanism 146 comprises the second-rail-locking-mechanism 162 which are configured to lock the first-rail-slide-mechanism 144, the second-rail-slide-mechanism 146, and the stair-portion 142 respectively at a desired user-selected position via fastening to the open ends of one of the plurality of rungs 126 on the first-rail 128 and the second-rail 130. The folding stair assembly 110 provides an apparatus for accessing a substantially vertical item desired to be ascended 170.

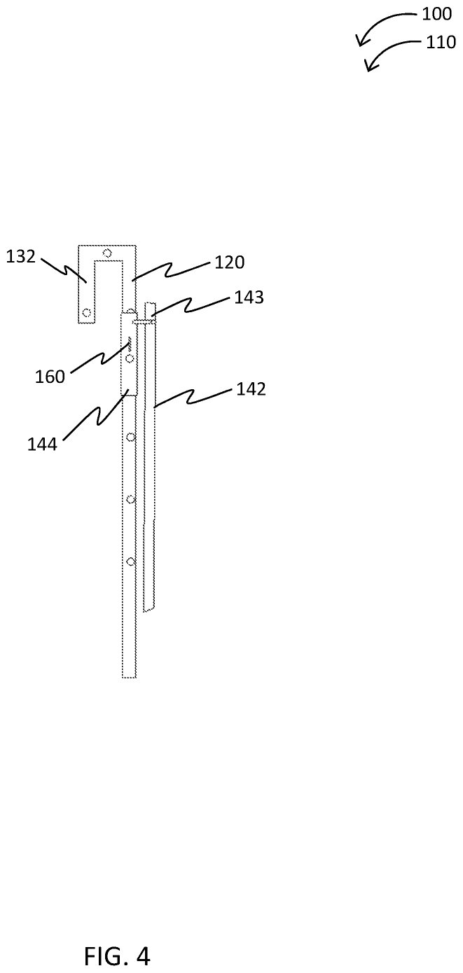

FIG. 4 shows a perspective view of the adjustable ladder and stair system 100 of FIG. 1, according to an embodiment of the present disclosure. As above, the adjustable ladder and stair system 100 may include the folding stair assembly 110 having the ladder-member 120 and the stair-member 140. The first-rail-slide-mechanism 144 and the second-rail-slide-mechanism 146 comprises a c-shaped profile configured to engage the first-rail 128 and the second-rail 130 as a track and move in relation to the first-end 122 to the second-end 124 of the ladder-member 120. In a preferred embodiment, first-rail-locking-mechanism 160 and the second-rail-locking-mechanism 162 comprise a cam handle and safety pin. The cam handle, when lifted, retracts the safety pin and allows for adjustability. A flat spring may be used, to apply pressure on the safety pin, to engage it, when the cam handle is put back to its original position. The safety pin secures the first-rail-slide-mechanism 144, the second-rail-slide-mechanism 146, and the stair-portion 142 at a desired position. The stair-portion 142 pivots to a sufficient angle in relation to the substantially vertical item desired to be ascended 170. Other suitable locking means may be used for the first-rail-locking-mechanism 160 and the second-rail-locking-mechanism 162.

In a preferred embodiment, the stair-member 140 further includes at least one hand rail 148. The at least one hand rail 148 is configured to fold flat against the stair-portion 142 when not in use. The at least one hand rail 148 is pivotal 90 degrees from the stair-portion 142. A user may walk up the stair-portion, grab the hand rail 148, and flip the hand rail 148 in to a vertical position or use. The hand rail 148 may be provided on at least one side of the stair-member 140.

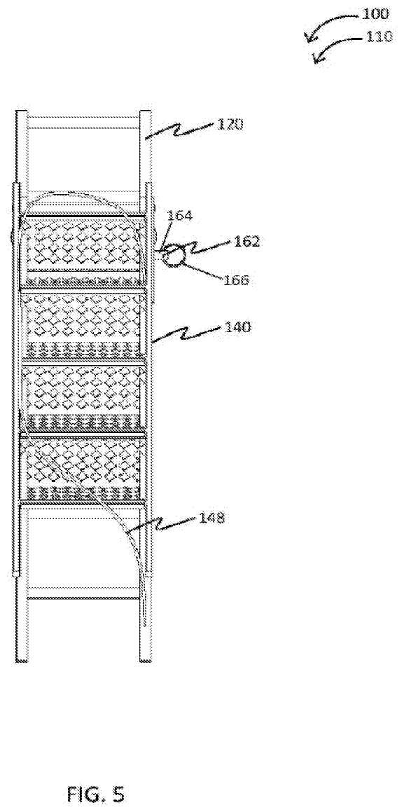

FIG. 5 shows a perspective view of the adjustable ladder and stair system 100 of FIG. 1, according to an embodiment of the present disclosure. As above, the adjustable ladder and stair system 100 may include the folding stair assembly 110 having the ladder-member 120 and the stair-member 140. The stair-portion 142 may comprise expanded metal. The expanded metal of the stair-portion 142 may include hand holes 152 for ease and safety, of adjusting and moving the stair-portion 142. The securer 132 secures the folding stair assembly 110 in a substantially vertical position along a substantially vertical item desired to be ascended 170. The securer 132 may include a hook. The securer 132 may further comprise an adjustable-depth-securer to accommodate the substantially vertical item desired to be ascended. The adjustable-depth-securer further comprises a lock to secure the securer 132 in a desired position during use.

The substantially vertical item desired to be ascended 170 comprises a garbage bin, formwork, wood walls, or other items as mentioned above in methods of use. The ladder-member 120 is parallel to the substantially vertical item desired to be ascended 170 and the stair-portion 142 extends from the substantially vertical item desired to be ascended 170 at an extended-angle when in use. The ladder-member 120 and the stair-member 140 are configured to be folded into a flat-position when not in use.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

That which is claimed:

1. An adjustable ladder and stair system comprising:
a folding stair assembly including:
a ladder-member having a first-end, a second-end, a plurality of rungs equidistantly spaced between a first-rail and a second-rail, and a securer;
a stair-member having a stair-portion, a C-shaped-first-rail-slide-mechanism, a C-shaped-second-rail-slide-mechanism comprising a first cam handle and a first safety pin, a C-shaped-first-rail-locking-mechanism, and a C-shaped-second-rail-locking-mechanism comprising a second cam handle and a second safety pin;
wherein each rung comprising said plurality of rungs comprises open ends;
wherein said first-end comprises said securer for attaching to an item and securing said folding stair assembly in position for use;
wherein said C-shaped-first-rail-slide-mechanism and said C-shaped-second-rail-slide-mechanism are positioned at a top-portion on opposing sides of said stair-portion and are configured to allow said stair-portion to pivot and further move along said first-rail and said second-rail; and
wherein said first-rail-slide-mechanism comprises said C-shaped-first-rail-locking-mechanism and said C-shaped-second-rail-slide-mechanism comprises said second-rail-locking-mechanism which are configured to lock said C-shaped-first-rail-slide-mechanism, said C-shaped-second-rail-slide-mechanism, and said stair-portion respectively at a user-selected position to said open ends of one of said plurality of rungs on said first-rail and said second-rail;
whereby said folding stair assembly provides an apparatus for accessing a substantially vertical item desired to be ascended.

2. The adjustable ladder and stair system of claim 1, wherein said stair-member further includes at least one hand rail.

3. The adjustable ladder and stair system of claim 2, wherein said at least one hand rail is configured to fold flat against said stair-portion when not in use.

4. The adjustable ladder and stair system of claim 3, wherein said at least one hand rail is pivotal 90 degrees from said stair-portion.

5. The adjustable ladder and stair system of claim 1, wherein said C-shaped-first-rail-slide-mechanism and said C-shaped-second-rail-slide-mechanism configured to engage said first-rail and said second-rail and move in relation to said first-end to said second-end of said folding-ladder-member.

6. (canceled)

7. The adjustable ladder and stair system of claim 1, wherein said first safety pin secures said C-shaped-first-rail-slide-mechanism with said stair-portion at a desired position and said second safety pin secures C-shaped-second-rail-slide-mechanism with said stair-portion at a desired position.

8. The adjustable ladder and stair system of claim 1, wherein said stair-portion comprises expanded metal.

9. The adjustable ladder and stair system of claim 8, wherein said expanded metal of said stair-portion comprises hand holes.

10. The adjustable ladder and stair system of claim 1, wherein said stair-portion comprises a run of approximately 9 inches and a rise of approximately 8 inches.

11. The adjustable ladder and stair system of claim 1, wherein said securer secures said folding stair assembly in a substantially vertical position along the e substantially vertical item desired to be ascended.

12. The adjustable ladder and stair system of claim 1, wherein said securer comprises a hook.

13. The adjustable ladder and stair system of claim 1, wherein said securer comprises an adjustable-depth-securer to accommodate the substantially vertical item desired to be ascended.

14. The adjustable ladder and stair system of claim 13, wherein said adjustable-depth-securer further comprises a lock.

15. The adjustable ladder and stair system of claim 1, wherein the substantially vertical item desired to be ascended comprises a garbage bin.

16. The adjustable ladder and stair system of claim 1, wherein said stair-portion is structured and arranged with said ladder-member to pivot to a sufficient angle in relation to the substantially vertical item desired to be ascended.

17. The adjustable ladder and stair system of claim 1, wherein said ladder-member is positioned parallel to the substantially vertical item desired to be ascended and said stair-portion extends from the substantially vertical item desired to be ascended at an extended-angle when in use.

18. The adjustable ladder and stair system of claim 1, wherein said ladder-member and said stair-member are configured to be folded into a flat-position when not in use.

19. The adjustable ladder and stair system of claim 1, wherein said plurality of rungs are separated by 12 inches along said first-rail and said second-rail.

20. An adjustable ladder and stair system, the adjustable ladder and stair system comprising:
a folding stair assembly including:
a ladder-member having a first-end, a second-end, a plurality of rungs equidistantly spaced between a first-rail and a second-rail, and a securer;
a stair-member having a stair-portion, a C-shaped-first-rail-slide-mechanism, a C-shaped-second-rail-slide-mechanism, a C-shaped-first-rail-locking-mechanism, and a C-shaped-second-rail-locking-mechanism.
wherein said ladder-member is parallel to a substantially vertical item desired to be ascended and said stair-portion extends from the substantially vertical item desired to be ascended at an extended-angle when in use;
wherein said plurality of rungs include open ends;
wherein said plurality of rungs are separated by 12 inches along said first-rail and said second-rail;
wherein said first-end comprises said securer for attaching to an item and securing said folding stair assembly in position for use;
wherein said securer secures said folding stair assembly in a substantially vertical position along the substantially vertical item desired to be ascended;
wherein said securer comprises a hook;
wherein said stair-portion comprises expanded metal;
wherein said expanded metal of said stair-portion comprises hand holes;
wherein said stair-portion comprises a run of approximately 9 inches and a rise of approximately 8 inches;
wherein said stair-member further includes at least one hand rail;
wherein said at least one hand rail is configured to fold flat against said stair-portion when not in use;
wherein said at least one hand rail is pivotal 90 degrees from said stair-portion;
wherein said C-shaped-first-rail-slide-mechanism and said C-shaped-second-rail-slide-mechanism are positioned at a top-portion on opposing sides of said stair-portion and are configured to allow said stair-portion to pivot and further move along said first-rail and said second-rail;
wherein said C-shaped-first-rail-slide-mechanism comprises said C-shaped-first-rail-locking-mechanism and said C-shaped-second-rail-slide-mechanism comprises said C-shaped-second-rail-locking-mechanism which are configured to lock said C-shaped-first-rail-slide-mechanism, said C-shaped-second-rail-slide-mechanism, and said stair-portion respectively at a desired user-selected position via fastening to said open ends of one of said plurality of rungs on said first-rail and said second-rail;
wherein said stair-portion pivots to a sufficient angle in relation to the substantially vertical item desired to be ascended;
wherein said C-shaped-first-rail-slide-mechanism and said C-shaped-second-rail-slide-mechanism is configured to engage said first-rail and said second-rail and move in relation to said first-end to said second-end of said ladder-member;
wherein said C-shaped-first-rail-locking-mechanism and said C-shaped-second-rail-locking-mechanism comprise a cam handle and safety pin;
wherein said safety pin secures said C-shaped-first-rail-slide-mechanism, said C-shaped-second-rail-slide-mechanism, and said stair-portion at a desired position; and
wherein said ladder-member and said stair-member are configured to be folded into a flat-position when not in use;
whereby said folding stair assembly provides an apparatus for accessing the substantially vertical item desired to be ascended.
